(19) United States
(12) Patent Application Publication
(10) Pub. No.: US 2009/0276934 A1
(43) Pub. Date: Nov. 12, 2009

(54) Multi-layer adhesive disposable bib

(76) Inventors: Marcia W. Lindsay, Apache Junction, AZ (US); James A. Lindsay, Apache Junction, AZ (US)

Correspondence Address: MARCIA W. LINDSAY, 53 N. Mountain Road #38, Apache Junction, AZ, 85220-3557, US

(21) Appl. No.: 12/231,874

(22) Filed: Sep. 8, 2008

Related U.S. Application Data
(60) Provisional application No. 61/001,548, filed on Nov. 3, 2007.

(51) Int. Cl. A41B 13/10; B32B 3/06

(52) U.S. Cl. 2/49.4; 428/57

(57) ABSTRACT

A multi-layer adhesive disposable bib is provided. The layers of material of the bib are ultrasonically bonded together. The first layer is located at the exterior surface of the bib and is made of a lightweight, non-woven material which is tear resistant and lint resistant. The second layer is composed of highly absorbent tissue paper to absorb liquids. The third layer is a waterproof polypropylene film that is impermeable to liquids and also provides additional strength to the bib. The fourth layer is located at the other exterior surface of the bib and is made of an adhesive. The bib may be adjustably secured about one's shoulders and not around their neck by means of full adhesive backing. The adhesive closure accommodates different sizes and desired closeness of fit yet releases easily to eliminate a choking hazard. These features plus the easy on and easy off add up to a low-cost, high performance product. This bib is a multi-purpose bib for everyone, of all ages, from infant to seniors and from the healthy to the sick.

### REFERENCES CITED

### U.S. Patent Documents

U.S. Pat. No. 3,979,776 September 1976 Gruenwald
U.S. Pat. No. 4,475,250 October 1984 Savin et al.
U.S. Pat. No. 4,620,323 November 1986 Tepper
U.S. Pat. No. 4,733,411 March 1988 Foti
U.S. Pat. No. 4,884,299 December 1989 Rose
U.S. Pat. No. 5,306,237 April 1994 Hahn et al.
U.S. Pat. No. 5,432,952 July 1995 Tate
U.S. Pat. No. 5,881,382 March 1999 Bernard et al.
U.S. Pat. No. 6,679,048 June 2000 Campbell
U.S. Pat. No. 6,212,683 April 2001 Liebmann
U.S. Pat. No. 6,256,788 July 2001 Loewer et al.
U.S. Pat. No. 6,261,278 July 2001 Chen et al.
U.S. Pat. No. 6,413,603 July 2002 Horton et al.
U.S. Pat. No. 7,103,916 September 2006 Goodew et al.

### DESCRIPTIONS

1. Field of Invention

The present invention relates to a Multi-Layer Disposable Adhesive Bib, that is lightweight, lint free and eye pleasing in design and super absorbent. This bib is attached to the wearer's shirt or outer garment by removing the protective paper backing on the fully adhesive back. Placing the bib on the top of the shoulder and securing it firmly to the top of the shoulders and pressing it securely to the front of the outer garment. More particularly, the bib is useful for food serving, drinking, nursing or just protecting the garments of the wearer.

2. Background of the Invention

As everyone knows to those skilled in the art, young children soil themselves and their clothing including the areas around them during any mealtime creating messy stains that are not always removed during laundry. These problems have typically been mitigated by the use of bibs to cover the area of the upper part of the body beneath the mouth of the wearer. Bibs are well known in the art.

Supervising adults at home will use multi-use fabric or plastic/vinyl bibs that collect the droppings during mealtime by the wearer. The bib that is soiled can then be laundered and reused at the next meal. In a restaurant in a public setting Disposable Bibs are normally provided by the parents for a mealtime.

As everyone knows Disposable bibs are designed to be worn only one time and then discarded. Normally, a bib includes a functional portion for at least partially covering/protecting a wearer's clothing, and a fastening portion for fastening the bib to the wearer. Typically, the closing device portion includes tie cords, loop fasteners, hook fasteners, buttons, clips, straps or tabs, hook and eye and velcro.

The bib will absorb liquids and trap them within the layers of absorbent tissue. By doing this it will prevent the liquid from reaching the wearer's clothes. Thus keeping the clothes totally dry, thus trapping in any possible germs or bacteria. This alone will help protect against germ diseases and other medical ailments (i.e., ear infections, colds, and upper respiratory problems). The Disposable Adhesive Bib closure accommodates different sizes and desired closeness of fit yet releases easily to eliminate a choking hazard. Upon completing use of this simply Disposal Adhesive Bib you simply throw it into a waste container.

### SUMMARY OF THE INVENTION

To the present invention there is provided a fully adhesive disposable bib that includes a sheet component, with a top edge, a bottom edge and first and second edges and a wearable component that has a front and back surface. The back surface is fully coated with an adhesive, so that the component will be disposed within an area of the sheet component defined by the top and bottom edges.

With respect to the invention, there is provided a disposable adhesive bib that includes a sheet component with a top edge, a bottom edge and first and second side edges, and front and back surfaces. The back surface of the sheet component is coated with an adhesive and a liner is disposed over the adhesive.

### BRIEF DESCRIPTION OF THE DRAWINGS

FIG. 1 is a top view of the multi-layer disposable adhesive bib according to an embodiment of the invention.

FIG. 2 is a perspective view of the 4 layers of the multi-layer disposable bib.

FIG. 3 is a side view of the embodiments of the multi-layer disposable adhesive bib.

### DETAILED DESCRIPTION OF THE INVENTION

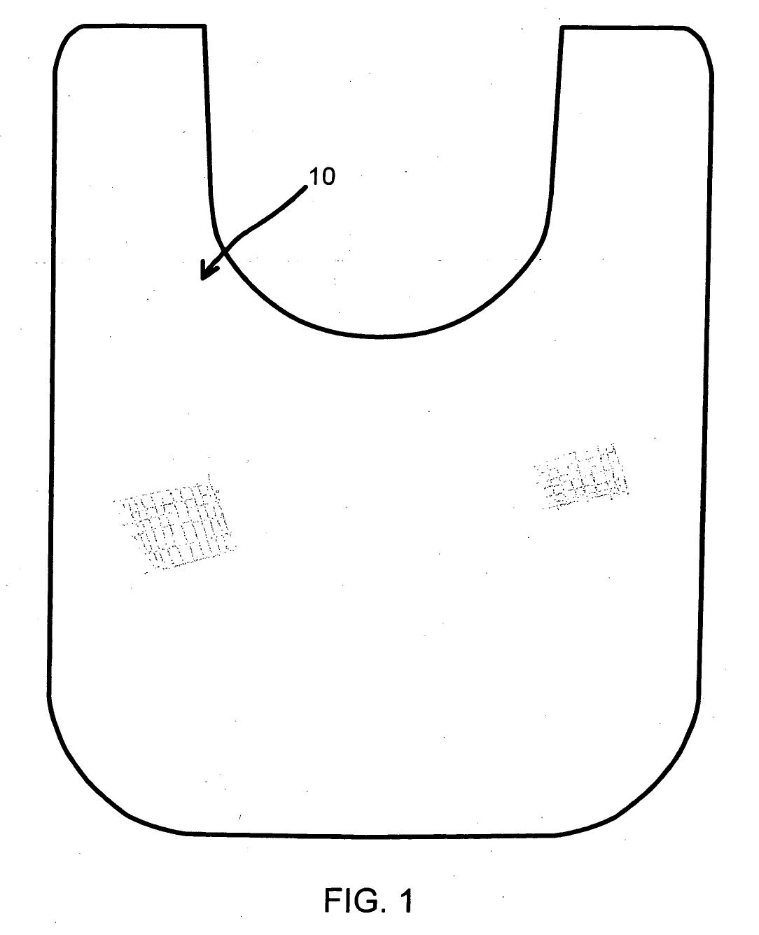

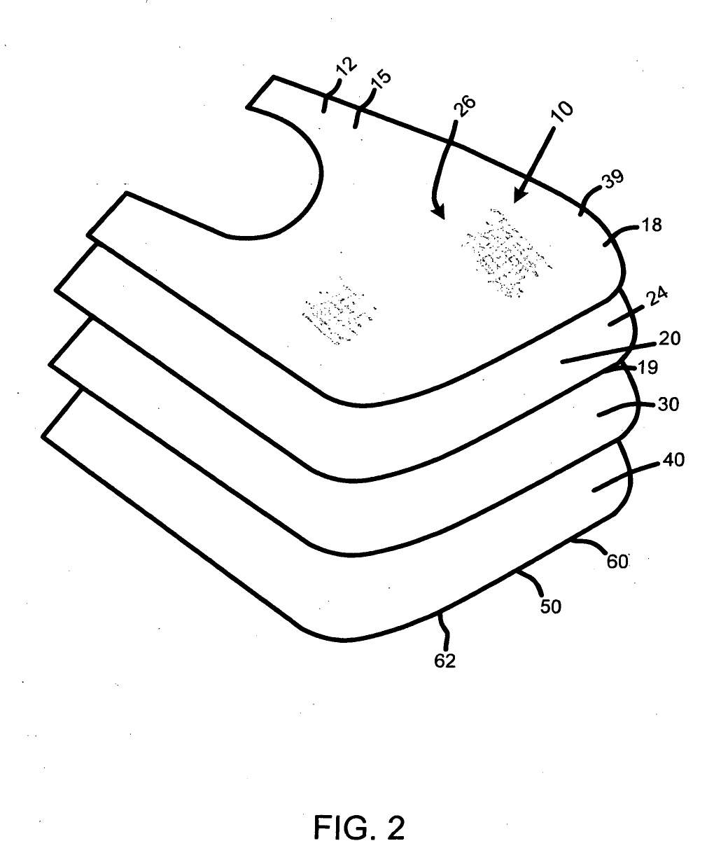

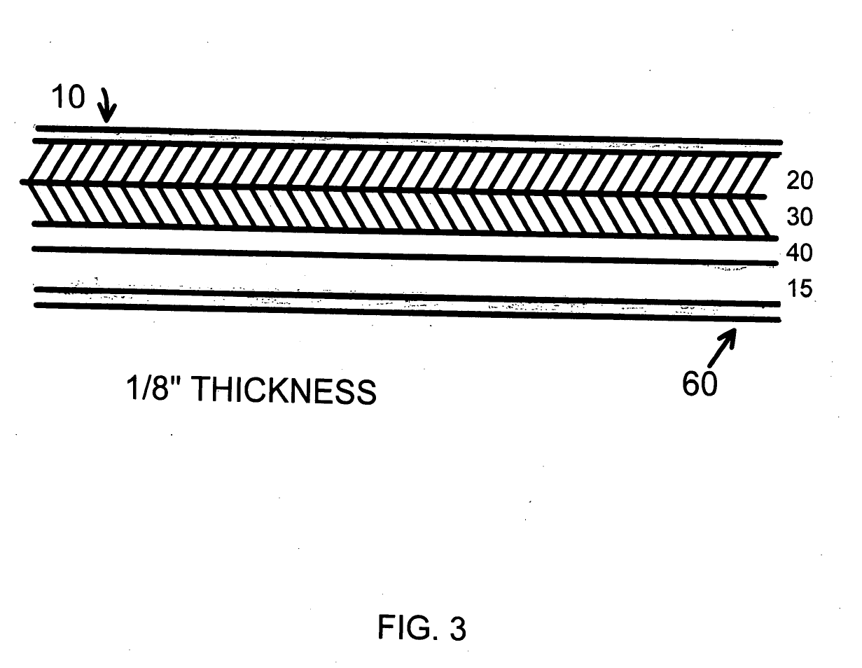

A preferred embodiment of the absorbent article of the present invention, Multi-Layer Disposable Adhesive Bib 10., is shown in a partially cut-away front plan view in FIG. 1, and in cross-sectional view in FIG. 2 and FIG. 3. The Multi-Layer Disposable Adhesive Bib 10, (known as Disposable Bib throughout this description) has a body-facing side that is in contact with the user's body and a garment-facing side that is in contact with the inner surface of the user's garment.

To retain the absorbed fluid in the interior the disposable bib 10 is provided with a core 15 is provided with a core 15. The core has a garment-facing side and a body facing side. The core 15 may be formed from any of the materials well known to those of ordinary skill in the art. Example of such materials include, multiple piles of crepe cellulose wadding, fluffed cellulose fibers, wood pulp fibers also know as air felt. Textile fibers, a blend of fibers, a mass of batt of fibers, a web of polymeric fibers, and a blend of polyester and polypropylene fibers.

Preferably, the core comprises a mass or batt of fibers. While many types of fibers may be used, a preferred material is a batt of polyester fibers.

To provide a degree of softness and a vapor previous covering for the garment-facing side of the disposable bib 10, an outer layer 18 is provided adjacent the core 15 on the garment-facing side of the core 10. While the outer layer 18 can be formed from any vapor, pervious material known in the art, a preferred material is a soft, smooth, compliant, liquid and vapor pervious material. Those skilled in the art may readily select woven and non-woven materials useful for the purpose, though non-woven materials are preferred. For example, porous materials used as top-sheets for disposable diapers or as coverings for conventional sanitary napkins can be used in the present invention.

Interposed between the core 15 and the outer layer 18 are a barrier layer 24. The barrier layer 24 prevents fluids. retained by the core 15 from striking through the disposable bib 10 and soiling adjacent garments. Therefore, the barrier layer must be fluid impervious. Suitable materials are well known in the art, including woven and non-woven fabrics that have been treated to render them repellent; breathable or vapor pervious, liquid resistant materials. Preferred materials are those materials that are fluid and vapor impervious, because they provide additional fluid strikethrough protection. Especially preferable materials include formed thermoplastic films. One especially suitable material is a polyethylene film having a thickness of from about 0.075 mils to about 1.25 mils, with a 1.0 mil thickness polyethylene film being especially suitable.

The shape of the barrier layer 24 is a factor in forming the ventilation area 19. The shape of the barrier layer 24 generally determines the number, size and location of the ventilation areas.

While the barrier layer 24 is substantially longitudinally coterminous with (i.e., the length) the bib 15, the barrier layer 24 must at least have an area in either of the end regions 12 and 14 which is a lesser transverse width than that end region 12 and 14, so that at least one ventilation area 18 is formed adjacent to the end region. Therefore, the barrier layer 24 may generally be of any shape that conforms to the above description.

A preferred shape of the barrier layer 24 is a shown in FIG. 2. The barrier layer has essentially a uniform transverse width. In addition, the barrier layer 24 has an even more preferred shape in which the uniform width is substantially the same transverse width as the narrowest portion of the middle region 16 of the disposable bib 10. With this preferable configuration, four ventilation areas 18 are formed in the disposable bib.

The barrier layer is preferably is secured to the other elements at the end regions 12 and 14 of the disposable bib 10. Because the barrier layer 24 is secured at the end regions 12 and 14, the barrier layer 24 has a reduced tendency to shift or bunch up with the disposable bib 10. The barrier layer may also be secured in the middle region 16 of the disposable bib 10. When the barrier layer 24 is secured in the middle region 16, the disposable bib 10, is more resistant to liquid strikethrough at the middle region where the greatest amount of protection against staining is required.

As is shown in FIGS. 2 and 3, the disposable bib 10, is preferably provided with an optional top-sheet 26. Any soft, smooth, compliant, porous material may form the top-sheet 26, which will be comfortable against human skin. In general, porous materials used as top-sheets for disposable diapers or as coverings for conventional sanitary napkins can be used in the present invention. Preferred top-sheets include formed thermoplastic films.

As illustrated in FIGS. 2 and 3, disposable bib 10 is provided with an optional wicking layer 28. The wicking layer 28 is preferably interposed between the core 15 and the top-sheet 26, although it is known in the art that the wicking layer 28 may be located in other areas including on the garment-facing side of the core 28. For example; the wicking layer may be interposed between the barrier layer and the core, or may completely surround the core. One suitable technique is the provision of a layer of fibers affixed to the inner surface of the top-sheet 26. Preferably, wicking layer 28 comprises a sheet of tissue paper closely associated with the inner surface of top-sheet 26. Tissue papers used in commonly available tissue products, such as those marketed under the registered trademark BOUNTY by Procter & Gamble Company of Cincinnati, Ohio can be used.

Referring to FIGS. 1, 2, and 3 which illustrate a preferred embodiment of the present invention, the open sheet 26 the wicking layer 28, the core 15, the barrier layer 24 and the outer layer 18 are secured to each other about the periphery of the disposable bib 10. with a seal 34.

Mechanical crimping, thermal welding, ultrasonic welding, adhesive bonding, etc. can achieve the seal 34. Although preferably seal 34 secures all of the above elements, several alternative embodiments are possible whereby some of the elements are not secured to the other elements by the seal 34.

The disposable bib 10, is provided with optional adhesive fastening means 60 as is illustrated in FIGS. 2 and 3. The adhesive fastening means 60 are illustrated as a full coating running the entire length of the disposable bib 10. This arrangement is selected for convenience; those skilled in the art can readily select a different pattern for the adhesive attachment means.

The purpose of the adhesive attachment means is to secure the disposable bib 10 in the chest region of the user's garment. An adhesive or glue used with sanitary napkins for such purposes can be used with this invention. Pressure sensitive adhesives are preferred. Suitable adhesives include Century A-305 IV manufactured by Century Adhesive Corporation and instant LOK 34-2823 manufactured by National Starch Company. Other means for physically securing the bib to the chest region of the user's garment can be used, but adhesive attachment means are preferred.

What this claims:

1. This Multi-Layer Disposal Adhesive Bib is comprised of a sheet component having a top edge bottom edge with first and second edges, along with a wearable component with a front and back surface, allowing the back surface to be covered/coated with the adhesive. The wearable component being easily disposed within an area of the sheet component defined by the top edge and bottom edge along with the first and second edges of the component.

2. The Multi-Layer Disposable Adhesive Bib of claim 1, as with the wearable component includes an upper edge, a bottom edge, first and second side edges, and a neck cut out along the top edge generally ½ between the first edge and the second edge.

3. A Multi-Layer Disposable Adhesive Bib component comprising of a first layer of absorbent material, having upper and lower surfaces.

4. A second layer comprising of a absorbent material component having upper and lower surfaces, the upper surface of which is positioned adjacent to the lower surface of which is positioned adjacent to the lower surface component of the first layer of absorbent material component.

5. A liquid impermeable third layer component, having upper and lower surfaces, the upper surface of which is positioned adjacent to the lower surfaces of the second layer of liquid impermeable material component, and the lower surfaces of which form the back exterior of the component.

6. A fourth layer of adhesive having upper and lower surfaces, the upper surface component of which is positioned to the third layer component and the lower surface component surfaces of which forms the back exterior of the component.

7. Ultrasonic bonds attaching component layers together to form the component.

8. A neck portion having a half circular aperture defined by shoulder straps extending from the narrow central portion of the bib.

9. The body portion including a narrowed bottom area extending to a wider central portion of the bib.

10. Adhesive backing associated with the shoulder straps for securing the component about the neck of the user.
